(19) United States
(12) Patent Application Publication
(10) Pub. No.: US 2004/0253045 A1
(43) Pub. Date: Dec. 16, 2004

(54) Notebook with elastic retaining mechanism

(76) Inventors: Carey L. Walley, Springboro, OH (US); Thomas J. Africa, Lebanon, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/462,189

(22) Filed: Jun. 16, 2003

(51) Int. Cl. B42F 3/06; B42F 13/04

(52) U.S. Cl. 402/57

(57) ABSTRACT

A notebook including a front cover, a rear cover pivotally joined to the front cover by a binding mechanism, and a retaining mechanism for maintaining the front and rear covers in a closed position wherein the front and rear covers are oriented generally parallel to each other. The retaining mechanism includes an elastic component coupled to at least one of the front or rear covers and having a pair of spaced apart loop portions, each of the loop portions being shaped to fit around a corner of each of the front and rear covers to maintain the covers in the closed position.

The present invention is directed to a notebook, and more particularly, to a notebook with an elastic retaining mechanism for retaining a cover in a closed position.

### BACKGROUND

Notebooks are often used by businesses, students, etc. in order to store loose items and provide a convenient carrying device. Such notebooks may include a binding mechanism and a plurality of papers stored therein such that the notebook can also provide a supply of writing paper. The notebook may include front and rear covers, and the covers may be able to be opened when using, storing or carrying the notebook. Accordingly, there is a need for a notebook having a retaining mechanism for retaining the notebook in its closed position to protect the papers or other components stored therein.

### SUMMARY

In one embodiment, the invention is a notebook having a front and a rear cover, and a retaining mechanism in the form of an elastic component which can fit around the front and rear covers to maintain the front and rear covers in a closed position. In one embodiment, the invention is a notebook including a front cover, a rear cover pivotally joined to the front cover by a binding mechanism, and a retaining mechanism for maintaining the front and rear covers in a closed position wherein the front and rear covers are oriented generally parallel to each other. The retaining mechanism includes an elastic component coupled to at least one of the front or rear covers and having a pair of spaced apart loop portions, each of the loop portions being shaped to fit around a corner of each of the front and rear covers to maintain the covers in the closed position.

Other objects and advantages of the present invention will be apparent from the following description and the accompanying drawings.

### BRIEF DESCRIPTION OF THE DRAWINGS

FIG. 1 is a front perspective view of one embodiment of the notebook of the present invention, with the retaining mechanism in its engaged position;

FIG. 2 is a back perspective view of the notebook of FIG. 1;

FIG. 3 is a front perspective view of the binder of FIG. 1, with the retaining mechanism moved to its disengaged position;

FIG. 4 is a front perspective view of the notebook of FIG. 3, with the front cover moved to its open position with corner portions of the top pages upturned;

FIG. 5 is a front perspective of the binder of FIG. 4, with all of the sheets of the notebook moved away from the rear cover;

FIG. 6 is a rear perspective view of the notebook of FIG. 2, with the retaining mechanism in its released disengaged position; and

FIG. 7 is a front end view of the notebook of FIG. 1, with one of the loops of the retaining mechanism located at an intermediate location of the thickness of the paper of the notebook.

### DETAILED DESCRIPTION

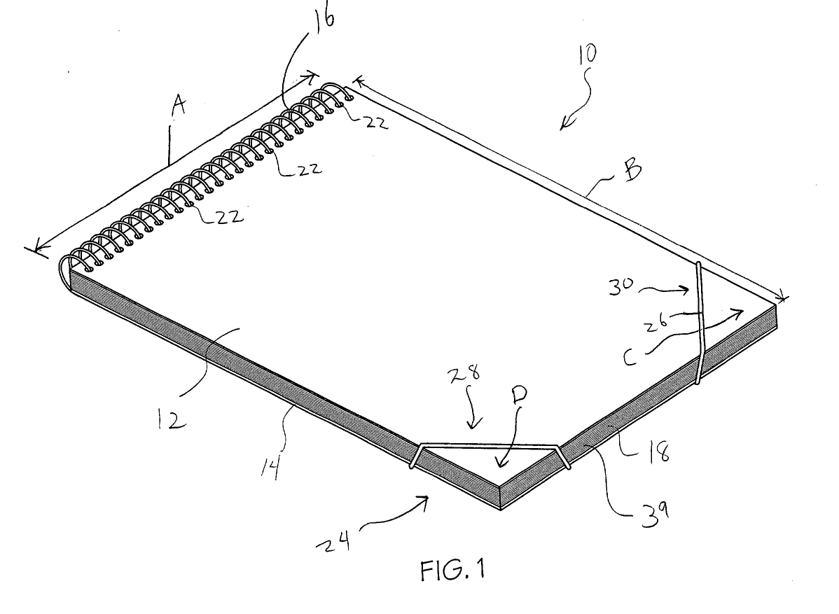

As shown in FIG. 1, in one embodiment, the notebook 10 of the present invention includes a front cover 12 and a rear cover 14 which are made from separate pieces of material and are pivotally joined together. For example, in the illustrated embodiment, the front 12 and rear 14 covers are pivotally joined by a binding mechanism 16, such as a coil or spiral binding mechanism. However, the front 12 and rear 14 covers can be pivotally joined together by a wide variety of methods, including but not limited to various other binding mechanisms, clasps, adhesives, as well as being directly joined together. Each of the front 12 and rear 14 covers may be generally rectangular in top view having a width A and a length B such that, in one embodiment, the covers 12, 14 may be pivotally joined along one of their width edges.

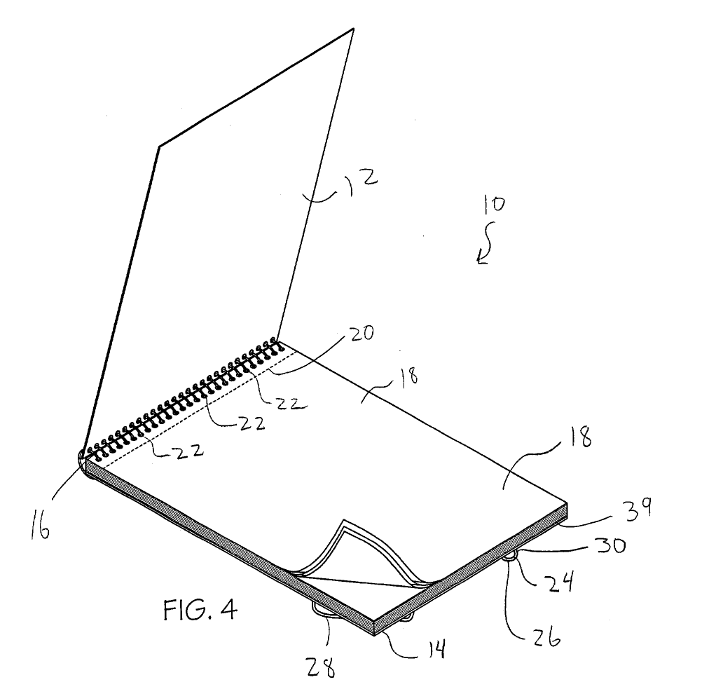

The notebook 10, and front 12 and rear 14 covers, may be able to be located in a closed position wherein the front 12 and rear 14 covers face each other and are oriented generally parallel to each other, as shown in FIG. 1. Furthermore, the front 12 and/or rear 14 covers may be able to be pivoted about the binding mechanism 16 away from the closed position, for example, as shown in FIG. 4. The notebook 10 may also include a plurality of papers 18 or other materials located between the front 12 and rear 14 covers when the notebook 10 is in its closed position. As shown in FIG. 4, each of the papers 18 may include a perforation or tear guide line 20 extending generally parallel to the binding mechanism 16 such that each of the papers 18 can be torn along its perforation line 20 and thereby be separated from the binding mechanism 16 and notebook 10.

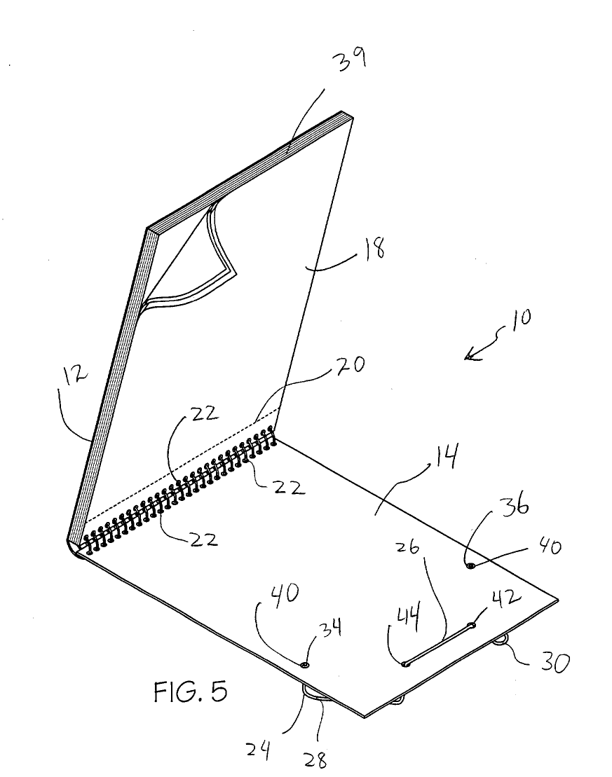

When the binding mechanism 16 is a spiral or coil binding mechanism, each of the covers 12, 14 and papers 18 may include a plurality of binding holes 22 located along a top or width edge thereof, such that each hole accommodates or receives a turn of the spiral or coil binding mechanism 16. In this manner, each of the papers 18 may be pivotally coupled to the binding mechanism 16 such that the papers 18 can be moved about or pivoted relative to the binding mechanism 16, as shown in FIG. 5.

The front 12 and rear 14 covers may be made of relatively stiff material to provide a relatively rigid surface to support the papers 18 when a user wishes to write thereon (i.e., when the notebook 10 is located on a user's lap). Further, in one embodiment, the rear cover 14 is made of significantly stiffer material than the front cover 12 so that the rear cover 14 may be used as the sole support structure when the front cover 12 is merely flipped open (FIG. 4) (that is, the front cover 12 is not folded around and behind the rear cover 14). Thus, in one embodiment, the rear cover 14 is made of relatively thick (i.e., 1/16 of an inch) cardboard and the front cover 12 may be made of a durable, protective plastic material.

In order to maintain the front 12 and rear 14 covers in their closed position, the notebook 10 may include a retaining mechanism, generally designated 24. In the illustrated embodiment, the retaining mechanism 24 includes an elastic component, such as an elastic cord or strap 26, fixedly and/or non-removably coupled to the rear cover 14, and having a pair of spaced-apart loop portions 28, 30. Each of the loop portions 28, 30 may be shaped to simultaneously fit around a corner of each of the front 12 and rear 14 covers to maintain the covers 12, 14 in the closed position.

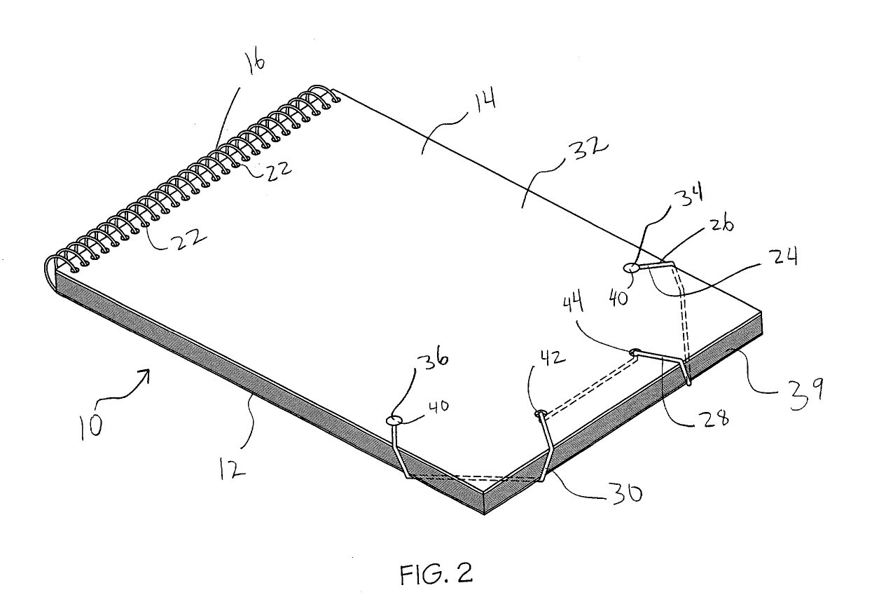

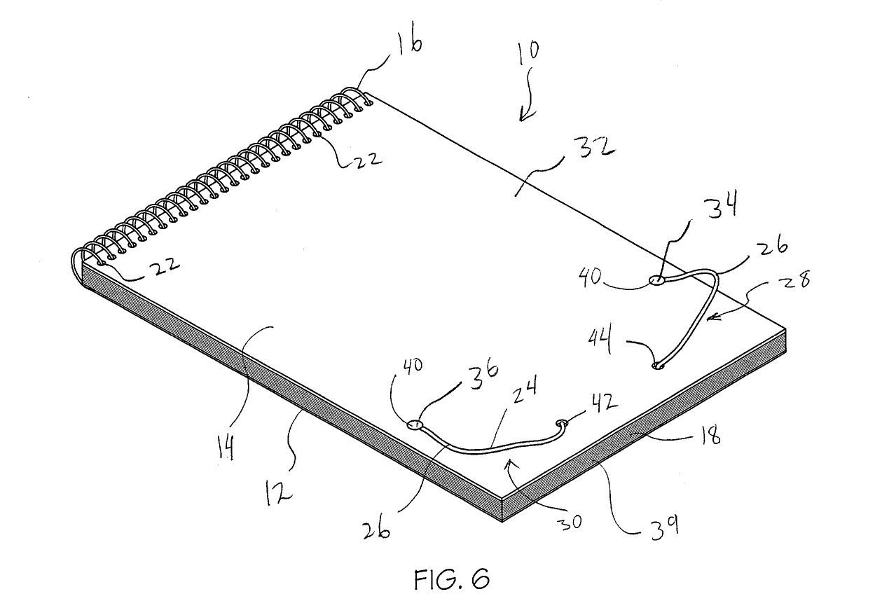

The elastic cord 26 may be a single cord which is fixedly coupled to the outer surface 32 of the rear cover 14 at a pair of spaced attachment points 34, 36 (FIG. 2). In the illustrated embodiment, the ends of the cord 26 are fixed to the rear cover 14 by rivets 40. The cord 26 may extend from the attachment point 36 to an opening 42 located in and through the rear cover 14. Thus, as shown in FIG. 6, when the elastic cord 26 is in its disengaged position (i.e., not fit around the corners of the covers 12, 14 and not maintaining the notebook 10 in its closed position), the cord 26 may extend on the outer surface 32 of the rear cover 14 from the attachment point 36 to the opening 42. The cord 26 may then extend through the opening 42 to the inner side of the rear cover 14 and to the other opening 44 of the rear cover 14 (FIG. 5). The cord 26 may then extend from the opening 44 to the attachment point 34 along the outer surface 32 of the rear cover 14 (FIG. 6). Because the cord 26 is a single cord, increasing the size of one loop portion 28, 30 such as by sliding the cord 26 through the openings 42, 44, decreases the size of the other loop portion 28, 30.

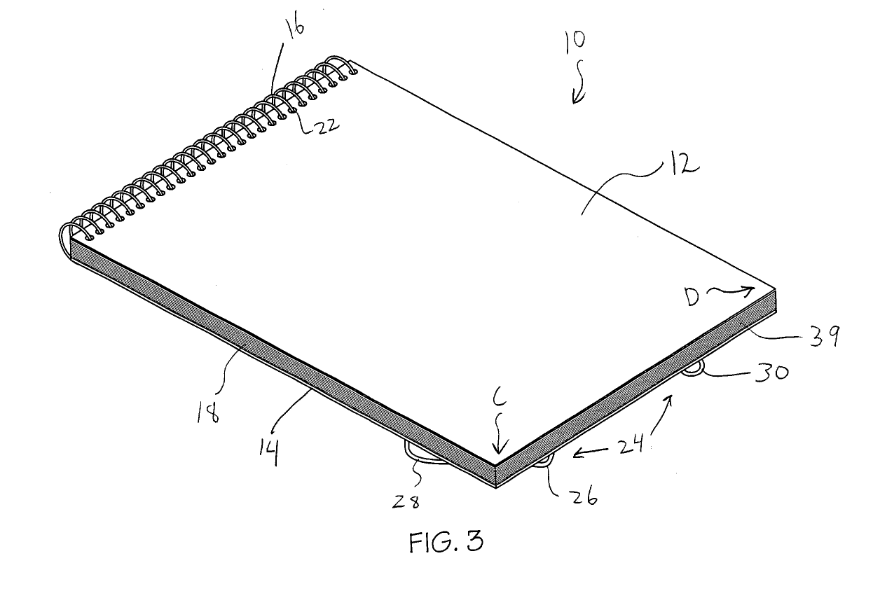

In order to maintain the covers 12, 14 in the closed positions, the front cover 12 is first moved to its closed position such that it is generally parallel to the rear cover 14 (FIG. 3). The loop portions 28, 30 are then wrapped around the comers C and D of the notebook 10 until the loop portions 28, 30 are at least partially located on the front cover 12, as shown in FIG. 1. The elastic nature of the cord 26 enables the cord 26 to stretch over and around the comers C and D which are at least partially located on the width edge 39 of the binder 10 that is spaced away from the binding mechanism 16. The tension forces in the elastic cord 26 can thereby maintain the covers 12, 14 in the closed position.

In order to move the retaining mechanism 24 to its released position (wherein the notebook is not maintained in its closed position such that the front cover 12 can be opened), the loop portions 28, 30 are stretched and looped around the comers C and D until the loop portions 28, 30 are fully located adjacent to the rear cover 14 (FIGS. 3 and 6). The front cover 12 can then be opened as shown in FIG. 4.

Of course, the orientation of the retaining mechanism 24 relative to the front 12 and rear 14 covers may be reversed such that the elastic cord 26 is fixedly coupled to the front cover 12 and the front cover 12 includes the attachment points 34, 36 and openings 42, 44 such that the elastic cord 26 can fit around the comers of the rear cover 14.

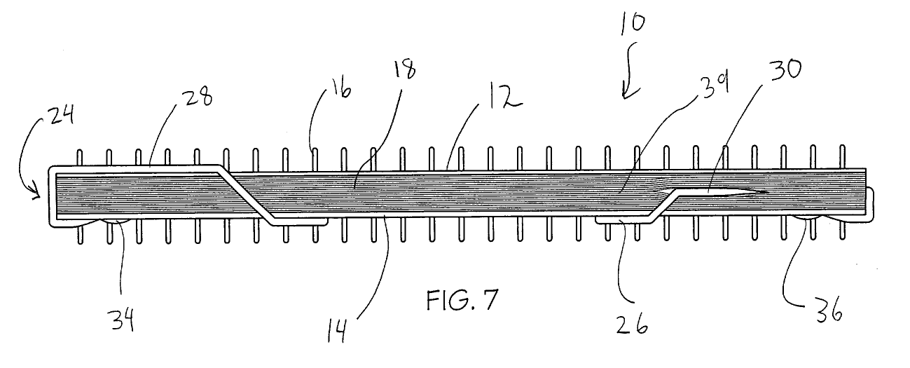

Furthermore, instead of retaining the front 12 and rear 14 covers in their closed position, the elastic cord 26 can also be placed at an intermediate location of the notebook 10 to serve as a place marker. For example, when the notebook 10 includes a plurality of sheets 18, the loops 28, 30 may be located on or adjacent to the sheets 18 desired to be marked by the user (for example, in the case of a student, to mark the latest page of notes). Furthermore, different ones of the loops 28, 30 may be used as place markers at different locations in the notebook 10. Finally, as shown in FIG. 7, one of the loops 30 may be located in an intermediate location of the papers 18 (and thereby used as a place marker) and the other loop 28 may be located over the front cover 14 to operate as a retaining mechanism. Thus, both of the loops 28, 30 can be used as either a place marker or as a retaining device.

Having described the invention in detail and by reference to the preferred embodiments, it will be apparent that modifications and variations thereof are possible without departing from the scope of the invention.

What is claimed is:

1. A notebook comprising:
a front cover;
a rear cover;
a binding mechanism pivotally joining said front cover and rear covers together; and
a retaining mechanism for maintaining said front and rear covers in a closed position wherein said front and rear covers are oriented generally parallel to each other, said retaining mechanism including an elastic component coupled to at least one of said front or rear covers and having a pair of spaced apart loop portions, each of said loop portions being shaped to fit around a corner of each of said front and rear covers to maintain said covers in said closed position.

2. The notebook of claim 1 wherein said notebook includes a plurality of papers coupled to said binding mechanism and located between said front and rear covers when said front and rear covers are in said closed position.

3. The notebook of claim 1 wherein said binding mechanism is a spiral or coil binding mechanism, and wherein each of said covers include a plurality of openings to receive a turn of said spiral or coil binding mechanism therethrough.

4. The notebook of claim 1 wherein each of said covers are generally rectangular and have a width and a length that is greater than said width, wherein said covers are pivotally joined by said binding mechanism along one of their width edges and wherein said loop portions are located to fit around the corners of said covers that are spaced away from the pivotally joined width edges.

5. The notebook of claim 1 wherein said elastic component is an elastic cord.

6. The notebook of claim 1 wherein said elastic component is directly fixedly and non-removably coupled to said one of said covers and is not directly fixedly coupled and non-removably coupled to the other of said covers.

7. The notebook of claim 1 wherein said elastic component is a single integral component such that said loops are formed of said single elastic component.

8. The notebook of claim 7 wherein increasing the size of one of said loop portions decreases the size of the other of said loop portions.

9. The notebook of claim 7 wherein said elastic component is fixedly coupled to said one of said covers at two spaced locations.

10. The notebook of claim 9 wherein said one of said covers includes a pair of spaced openings, and wherein said cord extends through both of said openings.

11. The notebook of claim 10 wherein when said retaining mechanism is in a disengaged position said elastic cord extends from one of said locations to one of said openings on one side of said one of said covers, extends through said one of said openings to the other of said openings on a second side of said one of said covers, and extends from the other of said openings to the other one of said locations on said first side of said cover.

12. The notebook of claim 1 wherein at least part of said binding mechanism extends through said front and rear covers.

13. A notebook comprising:
a front cover;
a rear cover, each of said covers being generally rectangular and having a width and a length that is greater than said width, said covers being pivotally joined together along one of their width edges; and
a retaining mechanism for maintaining said front and rear covers in a closed position wherein said front and rear covers are oriented generally parallel to each other, said retaining mechanism including an elastic component coupled to one of said front or rear covers and having a pair of spaced apart loop portions, each of said loop portions being shaped to fit around a corner of each of said front and rear covers to maintain said covers in said closed position, said loop portions being located to fit around the comers of said covers that are spaced away from the pivotally joined width edges.

14. The notebook of claim 13 further including a binding mechanism pivotally joining said front and rear covers.

15. The notebook of claim 14 wherein said binding mechanism is a spiral or coil binding mechanism, and wherein each of said covers include a plurality of openings to receive a turn of said spiral or coil binding mechanism therethrough.

16. The notebook of claim 14 wherein at least part of said binding mechanism extends through said front and rear covers.

17. The notebook of claim 14 wherein said notebook includes a plurality of papers coupled to said binding mechanism and located between said front and rear covers when said front and rear covers are in said closed position.

18. The notebook of claim 13 wherein said elastic component is an elastic cord.

19. The notebook of claim 13 wherein said elastic component is directly fixedly and non-removably coupled to said one of said covers and is not directly fixedly coupled and non-removably coupled to the other of said covers.

20. The notebook of claim 13 wherein said elastic component is a single integral component such that said loops are formed of said single elastic component.

21. The notebook of claim 20 wherein increasing the size of one of said loop portions decreases the size of the other of said loop portions.

22. The notebook of claim 20 wherein said elastic component is fixedly coupled to said one of said covers at two spaced locations.

23. The notebook of claim 22 wherein said one of said covers includes a pair of spaced openings, and wherein said cord extends through both of said openings.

24. The notebook of claim 23 wherein when said retaining mechanism is in a disengaged position said elastic cord extends from one of said locations to one of said openings on one side of said one of said covers, extends through said one of said openings to the other of said openings on a second side of said one of said covers, and extends from the other of said openings to the other one of said locations on said first side of said cover.

25. A notebook comprising:
a front cover;
a rear cover;
a plurality of papers, each of said papers and said covers being generally rectangular and having a width and a length that is greater than said width, said plurality of papers and said front and rear covers having generally the same size and shape in top view;
a binding mechanism pivotally joining said front cover, said rear cover and said plurality of papers together along one of their width edges, at least part of said binding mechanism extending through each of said covers and said plurality of papers; and
a retaining mechanism for maintaining said front and rear covers in a closed position wherein said front and rear covers are oriented generally parallel to and facing each other, said retaining mechanism including an elastic cord directly fixedly and non-removably coupled to two spaced locations on one of said covers and is not being directly fixedly coupled and non-removably coupled to the other of said cover, said retaining mechanism including a pair of spaced apart loop portions, each of said loop portions being shaped to fit around a corner of each of said front and rear covers to maintain said covers in said closed position, and wherein said loop portions are located to fit around the comers of said covers that are spaced away from the pivotally joined width edges of said front and rear covers.
